(19) United States
(12) Patent Application Publication
(10) Pub. No.: US 2022/0226786 A1
(43) Pub. Date: Jul. 21, 2022

(54) Magnetically Driven Liquid Dispersion Devices

(71) Applicant: Alexander G. Kolchinski, Winchester, MA (US)

(72) Inventor: Alexander G. Kolchinski, Winchester, MA (US)

(21) Appl. No.: 17/150,516

(22) Filed: Jan. 15, 2021

(51) Int. Cl. B01F 13/08

(52) U.S. Cl. CPC B01F 13/089; B01F 2215/0037; B01F 13/0863

(57) ABSTRACT

In accordance with aspects and embodiments, a magnetically driven liquid dispersion device is provided comprising a rotor, a funnel, and a rotary sprayer. The rotor is received by the funnel comprises an Archimedes screw and at least one diametric rotor magnet. The sprayer receives the funnel and comprises at least one diametric sprayer magnet. Application of an external rotating magnetic field generated by, for example, magnetic stirrer, causes the rotor to rotate within the funnel. Rotation of the rotor causes rotation of the sprayer about the funnel.

### FIELD OF DISCLOSURE

The present disclosure relates to laboratory mixing instruments, and more specifically to improved liquid dispersion devices driven by an external magnetic field that advantageously work with existing magnetic stirring devices.

### BACKGROUND

Dispersion is a widely used laboratory process whereby particles of a first material in a first phase are dispersed in a continuous phase of a second material. The two phases may be in the same or different states of matter. Dispersions may be homogenous or heterogenous mixtures.

Dispersion of liquids and other mechanisms of increasing liquid surface area are often used to enhance reaction efficiency and to facilitate various gas-liquid exchange processes. These processes, which include evaporation and gas absorption processes, are often carried out in chemically aggressive media in closed systems. These closed systems often have strict requirements for tightness between equipment components such that a vacuum is maintained and/or to contain the toxic materials that are the subject of the process. Rotary evaporators and chemical scrubbers are examples of such devices.

These devices have known drawbacks. For example, gaskets and seals are often required for the operation of these devices. However, these gaskets and seals often also have a detrimental effect on the vacuum or on the level of containment when compared to completely sealed systems, particularly when there are moving parts. Devices and methods that eliminate gaskets containing moving parts are therefore advantageous. For this reason, an external magnetic field such as the one generated by magnetic stirrers is often used as a driving force for various moving objects placed in chemically aggressive media. In addition, bumping, i.e., the rapid boiling that can occur when superheated liquid is nucleated, is known to occur in rotary evaporation systems. Bumping can cause boiling liquid to be expelled from its container, as well as container breakage, both of which are dangerous. Magnetic stirring of superheated liquids with a stir bar can reduce the risk of bumping.

In such applications, a magnetic spin bar is placed into a reaction mixture and rotation of the spin bar to achieve mixing is driven by a rotating magnetic field created by an external magnetic stir plate. In this particular magnetically driven application, the primary goal is to achieve stirring of a reaction mixture, but a certain level of dispersing is also achieved by this process. Other known devices employ magnetic fields to drive pumps for the purpose of dispersing liquid.

There thus exists a need for a magnetically driven liquid dispersion device able to disperse liquids in open and closed systems where any seals or gaskets are optional and do not involve moving parts. The present disclosure advantageously provides such a system and is able to disperse liquids without a pump, reduces the risk of bumping, and can be used in a variety of conventional distillation processes and chemical reactors.

### SUMMARY OF THE DISCLOSURE

The present disclosure relates to magnetically driven liquid dispersion devices configured to be used with existing magnetic stirring devices. In accordance with aspects and embodiments, a magnetically driven liquid dispersion device is provided comprising a rotor, a funnel, and a rotary sprayer. The rotor comprises an Archimedes screw comprising at least one diametric rotor magnet and the rotary sprayer comprises at least one sprayer magnet, and this magnet is preferably a diametric magnet. Diametric magnets are mostly represented by the diametrically magnetized (magnetized across the diameter) cylindrical bodies. Functionally equivalent though not as efficient are diametric composite magnets comprised of radially positioned axial magnets whose magnetization vector is perpendicular to the object's rotational axis.

The funnel comprises a first open end and a second end, and a first compartment at the first open end and a second compartment at the second end, the first compartment having a diameter preferably greater than the second compartment. The rotor has a diameter less than the diameter of the first funnel compartment and at least the first compartment is configured to receive the rotor. In some embodiments, the rotor may include a stem, and the stem may comprise at least one stem magnet, preferably a diametric magnet. The funnel holds the rotor, and thus the at least one diametric screw magnet in a vertical position.

In accordance with aspects and embodiments, the funnel defines a cavity above the rotor and the second compartment of the funnel comprises a plurality of openings. The sprayer comprises a bottom compartment and a top compartment, the bottom compartment comprises the at least one diametric sprayer magnet. The at least one diametric sprayer magnet is encapsulated in a solid, inert material. The sprayer comprises a hollow core having a diameter greater than the diameter of the second compartment of the funnel and the hollow core is configured to receive the second compartment of the funnel.

In accordance with aspects and embodiments, the sprayer is positioned on the funnel to align with the plurality of openings, and the top compartment of the sprayer comprises sprayer holes. In some embodiments, the sprayer rests on the top of the first compartment of the funnel. In other embodiments, the sprayer is positioned above the first compartment of the funnel. The rotor is configured to rotate within the funnel when exposed to an external rotating magnetic field. In accordance with aspects and embodiments, rotation of the rotor causes rotation of the sprayer about the second compartment of the funnel.

### BRIEF DESCRIPTION OF THE DRAWINGS

FIG. 1A shows a rotor of a magnetically driven liquid dispersion device with one encapsulated magnet in accordance with aspects and embodiments;

FIG. 1B shows an overhead view of rotor of a magnetically driven liquid dispersion device with one encapsulated magnet in accordance with aspects and embodiments;

FIG. 1C shows a rotor of a magnetically driven liquid dispersion device with two encapsulated magnets in accordance with aspects and embodiments;

FIG. 1D shows a rotor of a magnetically driven liquid dispersion device with a stem and three encapsulated magnets in accordance with aspects and embodiments;

FIG. 2A shows a funnel of a magnetically driven liquid dispersion device with a closed second compartment in accordance with aspects and embodiments;

FIG. 2B shows a funnel of a magnetically driven liquid dispersion device with an open second compartment in accordance with aspects and embodiments;

FIG. 2C shows a funnel of a magnetically driven liquid dispersion device with a closed second compartment and an additional joint in accordance with aspects and embodiments;

FIG. 3A shows a rotor and funnel assembly of a magnetically driven liquid dispersion device in accordance with aspects and embodiments;

FIG. 3B shows a rotor and funnel assembly of a magnetically driven liquid dispersion device in accordance with aspects and embodiments;

FIG. 4 shows a rotary sprayer of a magnetically driven liquid dispersion device in accordance with aspects and embodiments;

FIG. 5A shows a magnetically driven liquid dispersion device in accordance with aspects and embodiments;

FIG. 5B shows a magnetically driven liquid dispersion device in accordance with aspects and embodiments;

FIG. 6 shows a magnetically driven liquid dispersion device in a thin film evaporation system in accordance with aspects and embodiments;

FIG. 7 shows a magnetically driven liquid dispersion device in a modified thin film evaporation system in accordance with aspects and embodiments;

FIG. 8 shows a magnetically driven liquid dispersion device in a chemical scrubber system in accordance with aspects and embodiments; and

FIG. 9 shows a magnetically driven liquid dispersion device in a photochemical reactor system accordance with aspects and embodiments.

### DETAILED DESCRIPTION

The present disclosure provides an improved device for the dispersion of liquids, and more specifically provides a magnetically driven liquid dispersion device. The disclosed magnetically driven liquid dispersion devices are constructed of simple, known, components and are configured to be used with existing magnetic stirrer devices to achieve enhanced liquid dispersion. The enhanced dispersion achieved by the disclosed devices, specifically the thin film created by the devices, facilitates improved gas-liquid exchange and other chemical processes involving phase transfer.

The disclosed magnetically driven liquid dispersion devices include a rotor that comprises an Archimedes screw. An Archimedes screw, also known as a water screw or screw pump, is a screw that has helical surface surrounding a central cylindrical shaft, and in operation is fit inside a hollow pipe. As used herein, “Archimedes screw” refers to the screw itself, independent of any pipe surrounding it. When the bottom of the screw is inserted into a liquid and rotated axially, the bottom end of the screw scoops up a volume of liquid. As the shaft turns, liquid is pushed vertically up the pipe/tube surround the screw by the rotating helicoid until it pours out from the top of the pipe/tube surrounding the screw. As used herein, the rotor may also be called a “spin bar” by those of skill in the art, and the terms may be used interchangeably.

The Archimedes screws of the present disclosure include one or more diametrically magnetized inserts encapsulated in the screw shaft. Diametrically magnetized magnets are magnetized across their diameter, rather than axially, i.e., along the axis of the magnet. The north and south poles in cylindrically shaped diametric magnet are, for example, located on the curved surfaces of the magnetic at opposite sides. Notably, the magnets in traditional spin bars used with magnetic mixing devices are axially magnetized.

The Archimedes screws having diametric magnets are housed in an inverted funnel having dispersion openings in the void in the funnel above the screw. These openings fluidly connect the rotor compartment of the funnel to a rotary sprayer. The rotary sprayer comprises an additional diametric magnet, which magnetically couples the rotor to the rotary sprayer. The rotor couples to an external magnetic field, i.e., the magnetic field generated by a magnetic stirrer. The rotating external magnetic field causes rotation of the rotor, and thus Archimedes screw, within the funnel. Liquid accumulates above the screw and is dispersed through the openings in the funnel. The sprayer in turn spins in the rotating magnetic field generated by the one or more magnets in the screw. As liquid is pushed up the funnel by the screw into the cavity above the screw, liquid is pushed out of the funnel openings, enters the rotary sprayer, and is dispersed by pressure buildup and centrifugal force. As can be understood, the present disclosure is most effective for use with liquids, dispersion, and mixtures, and may experience decreased and limited effectiveness for compositions having a significant amount of solids and/or relatively large solids elements. In most embodiments, the sprayer disclosed herein is used in conjunction with the Archimedes screw rotor. However, it should be understood that in other embodiments, the sprayer may also be used in conjunction with a traditional magnetic spin bar.

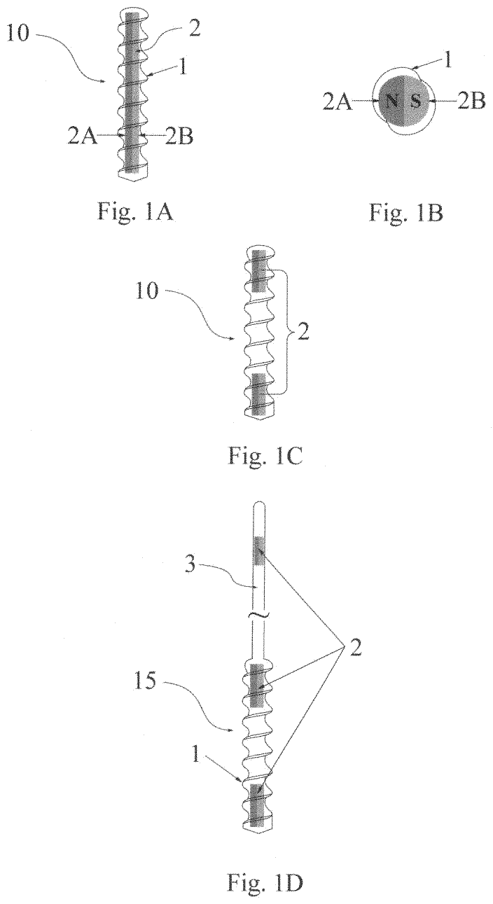

In accordance with aspects and embodiments, rotors for the disclosed liquid dispersion device are shown in FIGS. 1A-1D. Referring to FIGS. 1A-1B, rotor 10 has Archimedes screw 1 and diametric magnet 2. Diametric magnet 2 has poles 2A and 2B and is positioned vertically and within screw 1. Archimedes screw 1 may have one or more start threads, and may, for example, have one start, thread, two start threads, or three start threads. An exemplary two-start thread screw 1 is shown FIG. 1B. The threads may further be right or left-handed screw threads depending on the type of magnetic stirrer being used. For example, right-handed stirrers such as those manufactured by Corning and ChemGlass require a right-handed screw thread whereas left-handed stirrers, such as those manufactured by Heidolph, require a left-handed screw thread. Archimedes screw 1 is constructed from an inert material and is most preferably constructed of polytetrafluoroethylene (PTFE). Diametric magnets 2 may be neodymium magnets. Other suitable materials for Archimedes screw 1 and diametric magnet 2 will be readily selected by those of skill in the art. Materials for the Archimedes screw may include various fluorinated polymers, while magnets may also include high temperature neodymium magnets and cobalt-samarium magnets.

As shown in FIG. 1C, rotor 10 may have a plurality of diametric magnets 2. Rotors 10 are suitable for use in single flask processes. Rotors for use in stacked flasks may have additional components. For example, and referring to FIG. 1D, rotor 15 for use with stacked flasks has Archimedes screw 1 and stem 3. Screw 1 of rotor 15 includes one or more encapsulated diametric magnets and is shown on FIG. 1D with two diametric magnets 2. Stem 3 of rotor 15 also has one or more diametric magnets encapsulated therein and is shown with a single diametric magnet 2 in stem 3. The number of diametric magnets 2 in a given rotor and their positions within the rotor will be readily selected by those of skill in the art.

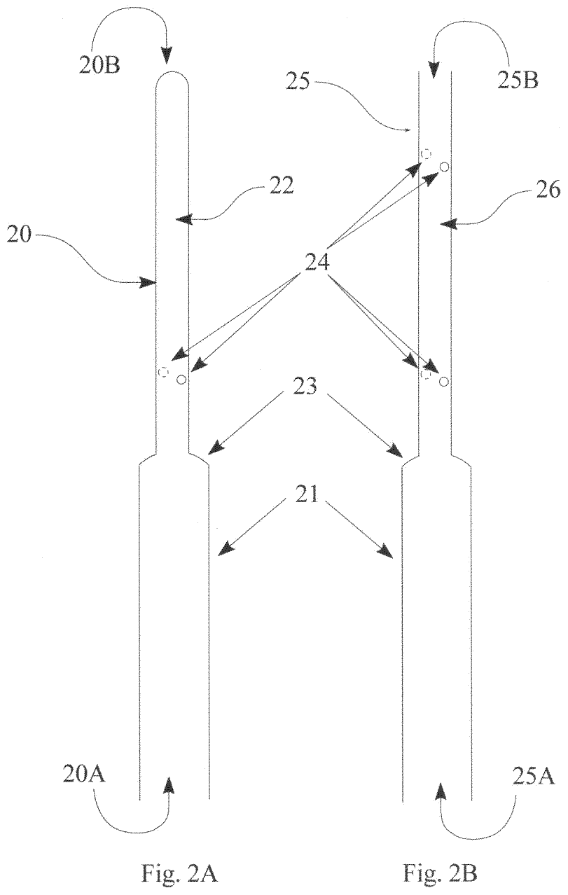

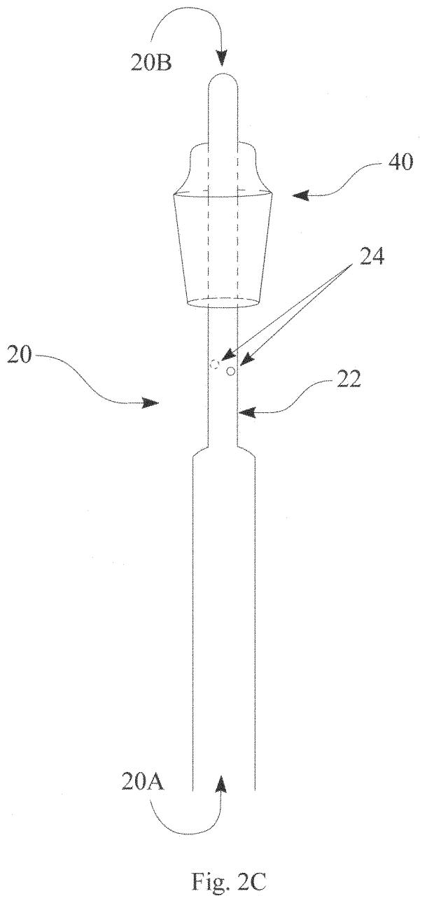

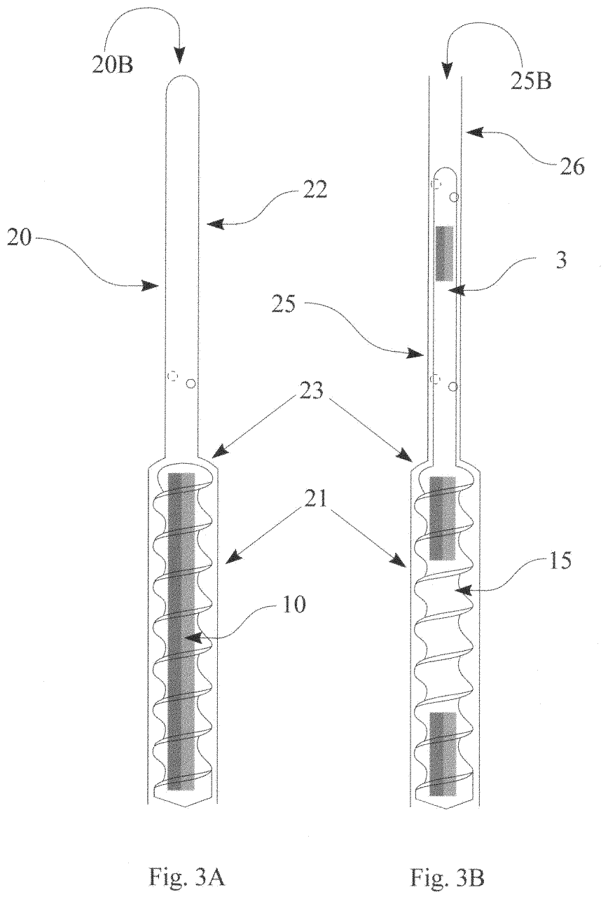

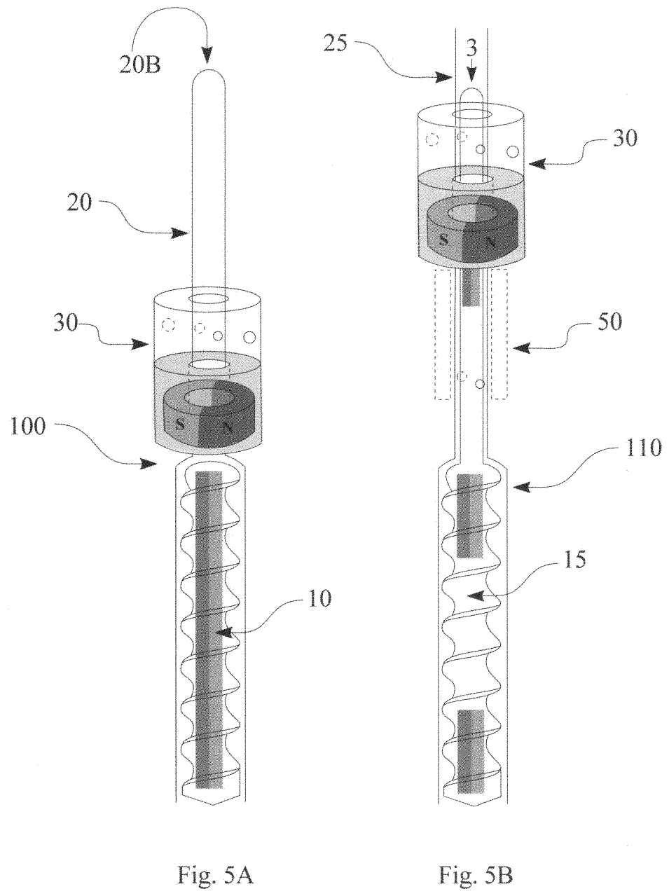

The rotors of the disclosed liquid dispersion device are positioned within inverted funnels. Funnels 20 and 25 of the disclosed liquid dispersion devices are shown in FIGS. 2A and 2B, respectively. Inverted funnel 20 has bottom 20A and top 20B. Bottom 20A is open and top 20B is closed. Funnel 20 has first compartment 21 having open end 20A and second compartment 22 having closed end 20B. Compartment 21 is preferably wider than compartment 22 and narrows at shoulder 23. Second compartment 22 has openings 24. Similarly, inverted funnel 25 has first compartment 21 and a second compartment 26. Inverted funnel 25 has bottom 25A and top 25B. Both 25A and top 25B are open. Compartment 21 is preferably wider than compartment 26 and narrows at shoulder 23. Second compartment 26 has openings 24. As shown on compartment 26, openings 24 may be grouped together and a plurality of groupings may be positioned on compartment 26, vertically spaced from one another. The size and shape of inverted funnels 20 and 25 are determined by the opening/joint sizes used in the chemistry apparatus. Closed funnels 20 are more universal and must be used under vacuum. Open funnels 25 can be used under normal pressure. The disclosed inverted funnels secure the rotor, and thus the encapsulated diametric magnets therein, in an upright position. As used herein, “upright position” includes substantially vertical positions, including rotors held at angles up to +/−15° from perpendicular to horizontal. Funnels of appropriate size and shape will be readily selected by those of skill in the art. In some embodiments, and referring to FIG. 2C, an additional joint 40 may be sealed to the funnel to eliminate any gaskets used to seal the connection between the device and the rest of the chemical apparatus. Sprayer 30 must be placed in advance onto compartment 22 prior to attaching joint 40 unless compartment 22 is equal or larger in diameter than compartment 21. In this case sprayer 30 may need to be supported by sleeve 50 as in FIG. 5B.

In accordance with aspects and embodiments and as shown in FIG. 3A, rotor 10 fits within compartment 21 of inverted funnel 20. As shown in FIG. 3B, rotor 15 fits within compartments 21 and 26 of inverted funnel 25. The diameter of compartment 21 of funnels 20 and 25 is slightly greater than the diameter of Archimedes screw 1 of rotors 10 and 15. The diameter of compartment 26 of funnel 25 is similarly slightly greater than the diameter of stem 3. The difference in diameter between rotors 10 and 15 and compartment 21 of funnels 20 and 25 respectively may be about 1-2 mm. These differences in diameters allow rotors 10 and 15 rotate freely within funnels 20 and 25 and allow the liquid to reach opening 24 bypassing stem 3.

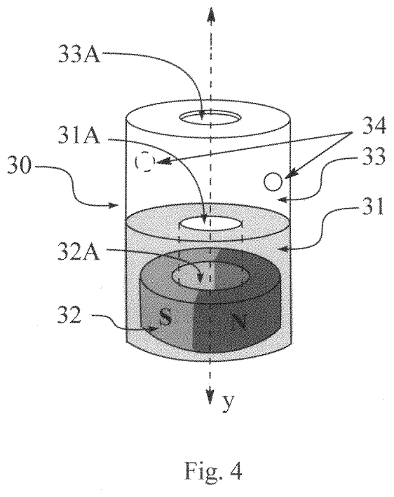

A magnetic rotary sprayer is fit onto the narrow compartment of the funnel and positioned to surround openings in the narrow compartment of the funnel. In accordance with aspects and embodiments and referring to FIG. 4, rotary sprayer 30 has bottom compartment 31 and top compartment 33. Sprayer 30 is configured to receive the narrow compartment of an inverted funnel. Bottom compartment 31 contains diametric magnet 32. Bottom compartment 31 is constructed of a solid, inert material, such as PTFE and has hollow core 31A. Diametric magnet 32 has hollow core 32A, which aligns with hollow core 31A to allow passage of the narrow compartment of an inverted funnel through both solid compartment 31 and magnet 32 encased therein. Upper compartment 33 defines an empty space having top opening 33A. Opening 33A aligns with hollow core 31A. Upper compartment 33 has sprayer holes 34. Although sprayer 30 is shown with a single diametric magnet, in some embodiments, sprayer 30 more comprise a plurality of diametric magnets. In other embodiments, sprayer 30 may instead include a plurality of axial magnets position radially.

Complete assemblies of magnetically driven liquid dispersing devices are shown in FIGS. 5A and 5B. In accordance with aspects and embodiments and referring to FIG. 5A, rotary sprayer 30 is fit onto narrow compartment 22 of inverted funnel 20. Top compartment 33 of rotary sprayer 30 aligns with openings 24 in compartment 22 of funnel 20. Rotary sprayer 30 rests on shoulder 23 of funnel 20 and surrounds openings 24. Similarly, and referring to FIG. 5B, rotary sprayer 30 is fit onto narrow compartment 26 of inverted funnel 25. Rotary sprayer 30 may be adjusted to align with a grouping of openings 24. As shown in FIG. 5B, a sleeve 50 may be fit onto narrow compartment 26 of funnel 25 and may provide additional support for the rotary sprayer 30 such that rotary sprayer 30 is positioned on compartment 26 at height above shoulder 23. Sleeve 50 may also cover one or more groupings of openings 24 and may be airtight.

In operation, the disclosed magnetically driven liquid dispersing devices are positioned in an external rotating magnetic field, i.e., on top of a magnetic stirrer. Referring to FIG. 5A as an example, bottom 20A of funnel 20 is positioned in a flask containing liquid reaction mixture. The diametric magnet 2 in rotor 10 magnetically couples to the external rotating magnetic field and the external field causes rotor 10 to rotate within compartment 21 of funnel 20. Liquid is scooped up by screw 1 at open end 20A and is directed upward along the screw threads towards end 20B of funnel 20. When liquid reaches the top of screw 1 at shoulder 23 of funnel 20, it is further directed into empty compartment 22. Fluid directed into compartment 22 exits funnel 20 via openings 24 and enters compartment 33 of rotary sprayer 30. Diametric magnet 32 in sprayer 30 magnetically couples to diametric magnet 2 in rotor 10, which causes sprayer 30, having a hollow core, to rotate about compartment 21 of funnel 20. As fluid enters compartment 33, centrifugal force causes the liquid to exit compartment 33 through sprayer holes 34. The liquid sprayed out of sprayer holes 34 is dispersed onto the interior walls of the flask. The dispersion of liquid onto the interior walls of the flask accelerates liquid evaporation. The setup may also be used to wash down solid crust formed on the flask walls above the reaction mixture.

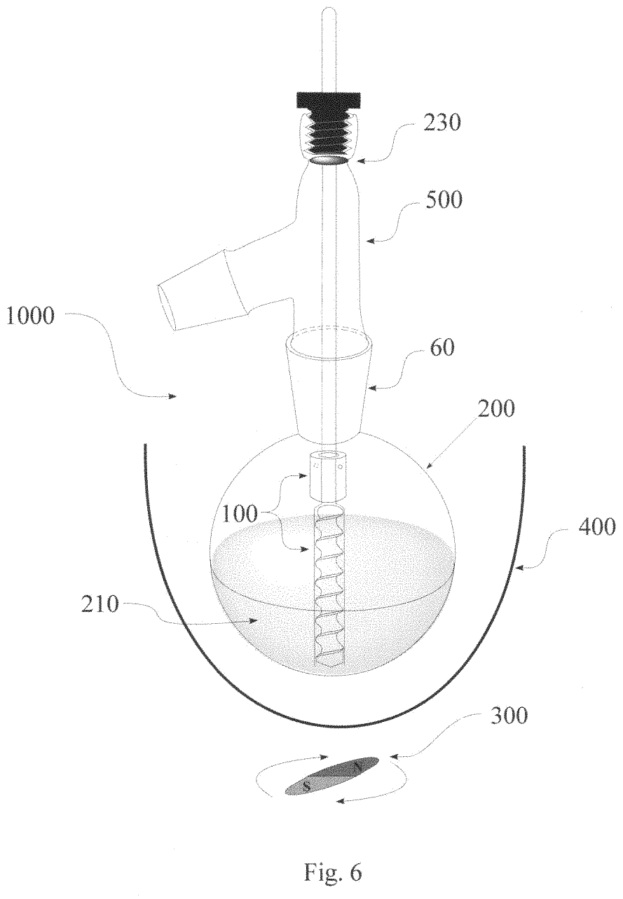

The disclosed magnetically driven liquid dispersion device may be used to accelerate liquid evaporation by dispersing liquid into the walls of a flask. In accordance with aspects and embodiments, and referring to FIGS. 5A and 6, thin film vacuum evaporator system 1000 is shown. Magnetically driven dispersion device 100 is placed in evaporating flask 200 containing liquid reaction mixture 210 via the distillation head 500 and stationary gasket seal 230. Joint 60 on flask 200 facilitates a sealed connection of the evaporating flask 200 to distillation head 500 having a condenser and vacuum port (not shown). Flask 200 containing liquid reaction mixture 210 sits on/in heat source 400, as in traditional rotary evaporation, however flask 200 advantageously does not rotate. Thus, a gasket able to maintain vacuum while holding a rotating flask in the rotary evaporator is advantageously omitted from system 1000 and replaced by the stationary gasket seal 230. Heating element 400 may be an oil bath, water bath, heating mantle, or any other suitable heat source. Magnetic stirrer 300 has one or more horizontally positioned axial magnets that generate an external rotating magnetic field. The external rotating magnetic field generated by magnetic stirrer 300 causes rotor 10 having diametric magnets 2 to rotate within flask 200. Diametric magnets 2 further couple to diametric magnet 32 in sprayer 30. Archimedes screw 1 of rotor 10 causes liquid 210 to travel upwards in inverted funnel 20 from compartment 21 to compartment 22, out of openings 24, and into sprayer 30. Sprayer 30 in turn disperses liquid 210 onto the interior walls of flask 200. Constant stirring of liquid 210 is achieved by rotor 10, which advantageously eliminates bumping commonly observed in rotary evaporators under vacuum. Moreover, system 1000 has a smaller footprint than traditional rotary evaporators, which advantageously allows for easy assembly in a fume hood. The stationary nature of system 1000 also allows for additional attachments to a multi-neck flask (which will be used in place of single neck flask 200). These attachments include, but are not limited to, an addition funnel, various sensors, and gas inlet tubes.

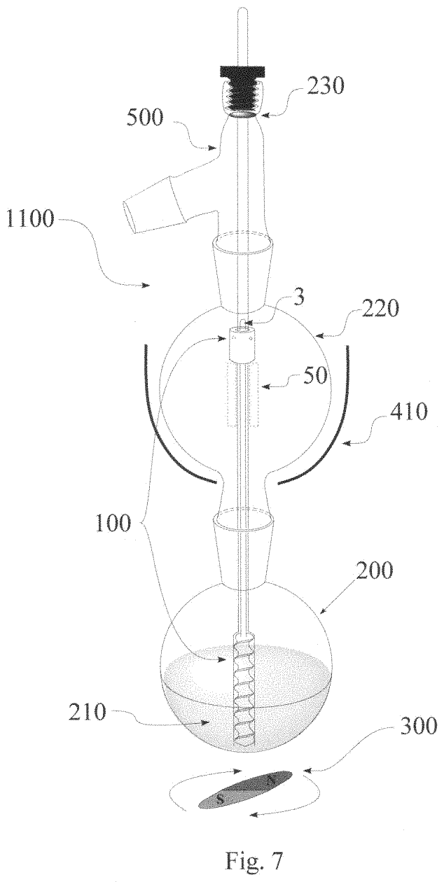

The disclosed magnetically driven liquid dispersion devices may be used in other distillation processes, including in dual flask thin film evaporator systems employed for less thermally stable liquids. In accordance with aspects and embodiments and referring to FIG. 7 and FIGS. 5A and B, system 1100 has flasks 200 and 220 in fluid communication with one another and distillation head 500. The flasks sit over magnetic stirrer 300. The bulk of liquid 210 is stored in flask 200 at or below room temperature. A magnetically driven liquid dispersion device 100 having rotor 15 with a stem 3 in funnel 20 is seated in flask 200 and extends through flask 220 and distillation head 500 to stationary gasket seal 230. Sprayer 30 on inverted funnel 20 is positioned within flask 220. The external rotating magnetic field generated by magnetic stirrer 300 causes rotor 15 having diametric magnets 2 to rotate within funnel 20. Diametric magnets 2 further couple to diametric magnet 32 in sprayer 30, causing it to rotate about compartment 22 of funnel 20. Archimedes screw 1 of rotor 15 causes liquid 210 to travel upwards in inverted funnel 20 from compartment 21 to compartment 22, out of openings 24 and into sprayer 30. Sprayer 30 in turn disperses liquid 210 onto the interior walls of flask 220. Flask 220 is heated with a heating mantle 410. Liquid dispersed onto the interior walls of flask 220 is partially distilled preferably under vacuum and partially returned to the bottom flask 200. System 1100 having magnetically driven liquid dispersion device 110 reduces overall residence time of liquid 210 at elevated temperatures.

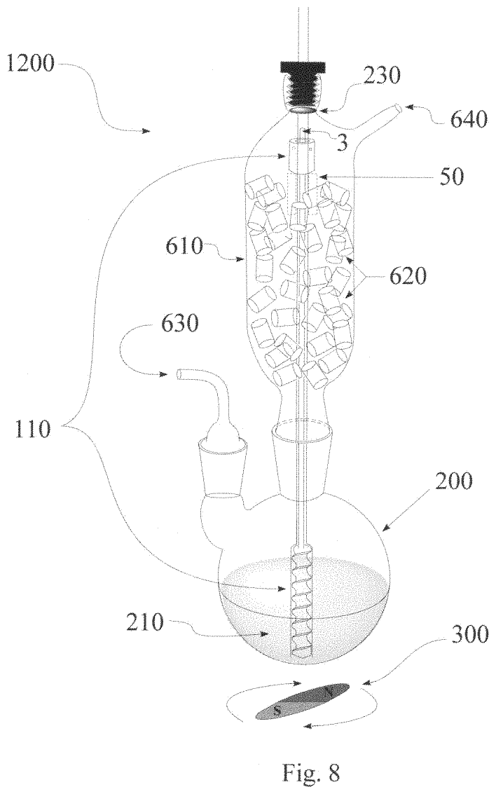

The disclosed magnetically driven liquid dispersion devices may further be used in chemical scrubber systems. In accordance with aspects and embodiments and referring to FIGS. 5B and 8, system 1200 has flask 200 containing liquid absorbent 210. Chemical scrubber 1200 has column 610 packed with media 620, and gas inlet 630 and gas outlet 640. A magnetically driven liquid dispersion device 110 having rotor 15 with stem 3 in funnel 25 is arranged in flasks 200 and column 610. Sprayer 30 is positioned within column 610 above media 620. The external rotating magnetic field generated by magnetic stirrer 300 causes rotor 15 which has diametric magnets 2 to rotate within funnel 20. Diametric magnets 2 further couple to diametric magnet 32 in sprayer 30. Archimedes screw 1 of rotor 15 causes liquid 210 to travel upwards in inverted funnel 25 out of openings 24, and into sprayer 30. Sprayer 30 in turn disperses liquid 210 at the top of column 610. Open end 25B can be used to sample liquid 210 to monitor consumption of the chemicals.

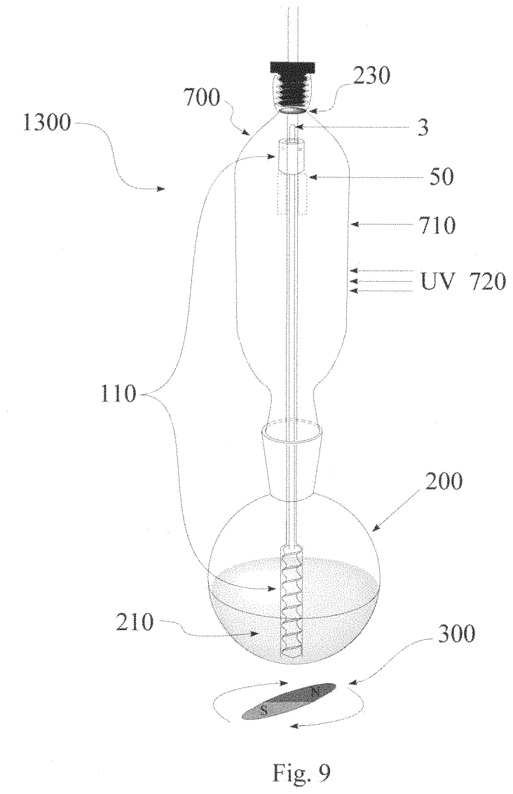

The disclosed magnetically driven liquid dispersion devices may also be used in reactors, including photochemical reactors. For example, and referring to FIGS. 5B and 9, magnetically driven liquid dispersion device 110 is used in photochemical reactor system 1300. System 1300 has flask 200 containing reaction liquid 210 over magnetic stirrer 300. Photochemical reactor 700 has quartz tube 710 connected to flask 200 and UV source 720. Magnetically driven liquid dispersion device 110 is positioned in flask 200 and extends through quartz tube 710 to stationary gasket seal 230. Sprayer 30 is positioned at the top of tube 710. The external rotating magnetic field generated by magnetic stirrer 300 causes rotor 15 having diametric magnets 2 to rotate within funnel 25. Diametric magnets 2 further couple to diametric magnet 32 in sprayer 30, causing it to rotate about compartment 26 of funnel 25. Archimedes screw 1 of rotor 15 causes liquid 210 to travel upwards in inverted funnel 25 from compartment 21 to compartment 26, out of openings 24 and into sprayer 30. Sprayer 30 in turn disperses liquid 210 onto the interior walls of tube 710, creating a thin film. The thin film of liquid 210 on interior walls of tube 710 absorbs UV irradiation. The thin film created by magnetically driven liquid dispersion device 110 facilitates photochemical reactions. Other suitable systems and configurations for the disclosed magnetically driven liquid dispersion devices will be readily selected by those of skill in the art.

Although certain representative embodiments and advantages have been described in detail, it will be apparent to those skilled in the art that various modifications and variations can be made in the present disclosure without departing from the scope or spirit of the disclosure. Other embodiments of the disclosure will be apparent to those skilled in the art from consideration of the specification and practice of the systems, processes, and methods disclosed herein. It is intended that the specification and examples be considered as exemplary only.

What is claimed is:

1. A magnetically driven liquid dispersion device comprising:
a rotor comprises an Archimedes screw having a first end and a second end; the Archimedes screw comprising at least one diametric rotor magnet;
a funnel; and
a rotary sprayer, the rotary sprayer comprising at least one diametric sprayer magnet.

2. The device of claim 1, wherein the funnel comprises a first open end and a second end, and a first compartment at the first open end and a second compartment at the second end, the first compartment having a diameter greater than the second compartment.

3. The device of claim 2, wherein the rotor has a diameter less than the diameter of the first compartment and at least the first compartment is configured to receive the rotor.

4. The device of claim 3, wherein the Archimedes screw comprises one diametric rotor magnet.

5. The device of claim 3, wherein the Archimedes screw comprises two diametric rotor magnets.

6. The device of claim 5, wherein the first diametric rotor magnet is positioned at the first end of the Archimedes screw and the second diametric rotor magnet is positioned at the second end of the Archimedes screw.

7. The device of claim 3, wherein the rotor comprises a stem, and the stem comprise at least one diametric stem magnet.

8. The device of claim 7, wherein the Archimedes screw comprises two diametric rotor magnets.

9. The device of claim 3, wherein the funnel holds the at least one diametric screw magnet in an upright position.

10. The device of claim 9, wherein the second compartment of the funnel defines a cavity above the rotor.

11. The device of claim 10, wherein the second compartment of the funnel comprises a plurality of openings.

12. The device of claim 11, wherein the sprayer comprises a bottom compartment and a top compartment, the bottom compartment comprising the at least one diametric sprayer magnet.

13. The device of claim 12, wherein the at least one diametric sprayer magnet is encapsulated in an inert material.

14. The device of claim 13, wherein the sprayer comprises a hollow core having a diameter greater than the diameter of the second compartment of the funnel and the hollow core is configured to receive the second compartment of the funnel.

15. The device of claim 14, wherein the rotary sprayer is positioned along the funnel to align with the plurality of openings.

16. The device of claim 15, wherein the top compartment of the rotary sprayer comprises sprayer holes.

17. The device of claim 16, wherein the rotary sprayer rests on the top of the first compartment of the funnel.

18. The device of claim 16, wherein the rotary sprayer is positioned above the first compartment of the funnel.

19. A magnetic stirring device comprising:
a rotor comprises an Archimedes screw having a first end and a second end, the Archimedes screw comprising at least one diametric magnet and at least one start thread.

20. The device of claim 19, further comprising a sprayer, the sprayer comprising a diametric magnet magnetically coupled to the diametric magnet of the Archimedes screw.
